(19) United States
(12) Patent Application Publication
(10) Pub. No.: US 2006/0231634 A1
(43) Pub. Date: Oct. 19, 2006

(54) Memory card structure

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Power Digital Card Co., Ltd.

(21) Appl. No.: 11/106,577

(22) Filed: Apr. 15, 2005

(51) Int. Cl. G06K 19/06

(52) U.S. Cl. 235/492

(57) ABSTRACT

A memory card structure includes primarily a memory card body manufactured by a one-piece ejection molding process, whose one side mounted with a slideway. Latching slots are located at an upper and a lower sides of the slideway, and a write-protect device is located on the slideway. Latching hooks are located on the write-protect device, at positions corresponding to the latching slots, so as to adjust a forward and backward position of the write-protect device on the slideway, and prevent a falling off of the write-protect device by a latching effect between the latching hooks and the slideway. In addition, the memory card can be assembled through a simple latching operation, thereby achieving objects of fast assembling, improving a productivity, and lowering a manufacturing cost.

### BACKGROUND OF THE INVENTION

(a) Field of the Invention

The present invention relates to a memory card structure, and more particularly to a memory structure that has a simple structure, can be quickly assembled, will not fall off, and can reduce a manufacturing cost.

(b) Description of the Prior Art

As the advancement of modern technology, the prosperity of information, and the continuous changing of electronic products, memory cards have become a most convenient data storage product with a very broad application including a high technology product such as a digital camera, a digital camcorder, and etc.

However, as the specifications of memory cards on the current market are not standardized, there are a variety of memory cards with different sizes, such as an XD card, an MMSD card, a SD card, an MMC card, etc., according to different brands. In addition to having a compact size, these products are equipped with a high compatibility, a low cost, a high storage capacity, a fast transmission speed, and a confidentiality.

Since the memory cards are primarily used for data accessing and writing through electronic products or card readers, a write-protect device will be mounted on some memory cards to prevent the memory cards from being carelessly accessed or written in. The conventional write-protect devices primarily use a supersonic process to fix the body of memory cards, which often causes the body of memory cards unable to be sealed, and thus causes a fall off of the write-protect devices, thereby losing an original function of the write-protect devices.

### SUMMARY OF THE INVENTION

Accordingly, the present invention includes a memory card body manufactured by a one-piece ejection molding process, with a slideway located at one side of the memory card. Latching slots are located at two sides at an upper and at a lower part of the slideway, and a write-protect device is mounted on the slideway. Latching hooks are located on the write-protect device at positions corresponding to the latching slots, so as to adjust a forward and backward position of the write-protect device on the slideway, and prevent the write-protect device from falling off through a latching function between the latching hooks and the slideway. In addition, the memory card can be assembled through a simple latching operation, thereby achieving objects of fast assembling, unable to fall off, and lowering a manufacturing cost.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows an assembly view of the present invention.

FIG. 3 shows a cutaway view of a portion of the present invention.

FIG. 4 shows a schematic view in a direction of movement of a write-protect device of the present invention.

FIG. 5 shows a schematic view in a direction of movement of another implementation of a write-protect device of the present invention.

### DETAILED DESCRIPTION OF THE PREFERRED EMBODIMENTS

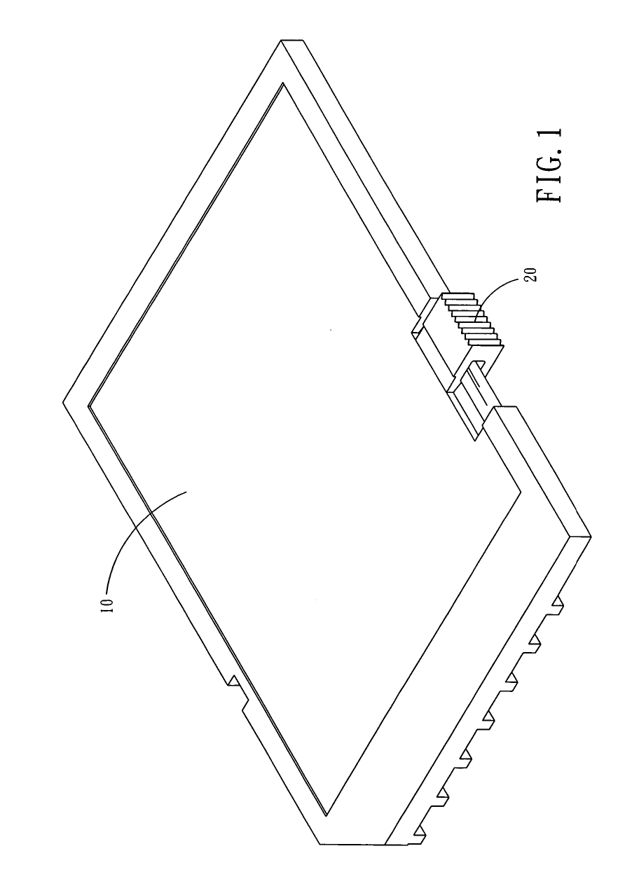

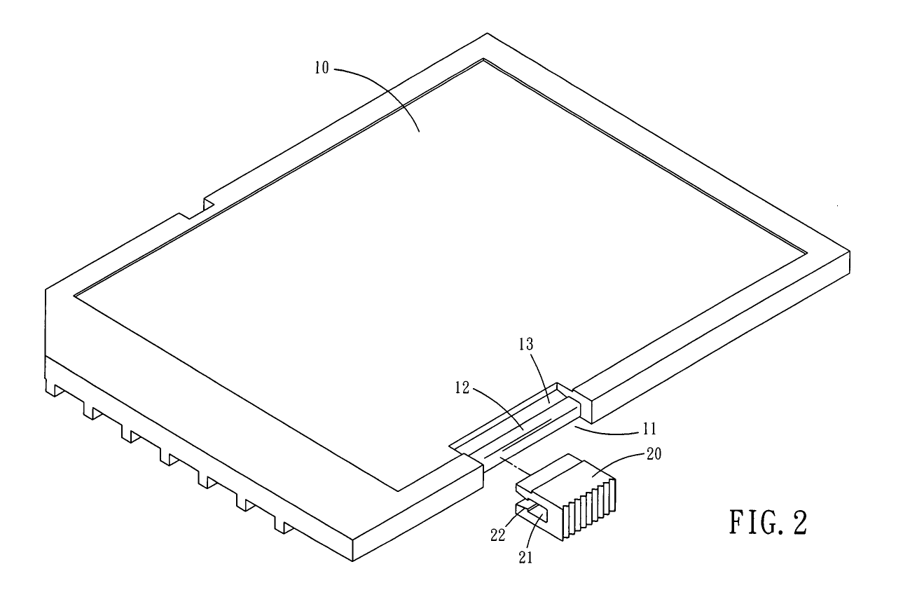

Referring to FIG. 1 and FIG. 2, the present invention comprises primarily a memory card body 10 mainly manufactured by a one-piece ejection molding process, and a notch 11 located at one side of the memory card body 10. A slideway 12 is protruded out from the notch 11, and latching slots 13 are located at two sides at an upper and a lower part of the slideway 12. A write-protect device 20 with a shorter length than that of the slideway 12 is latched on the slideway 12. On the other hand, a guiding slot 21 is located on the write-protect device 20 at a position corresponding to the slideway 12, and latching hooks 22 corresponding to the latching slots 13 are protruded out at an upper and a lower ends of the slideway 21.

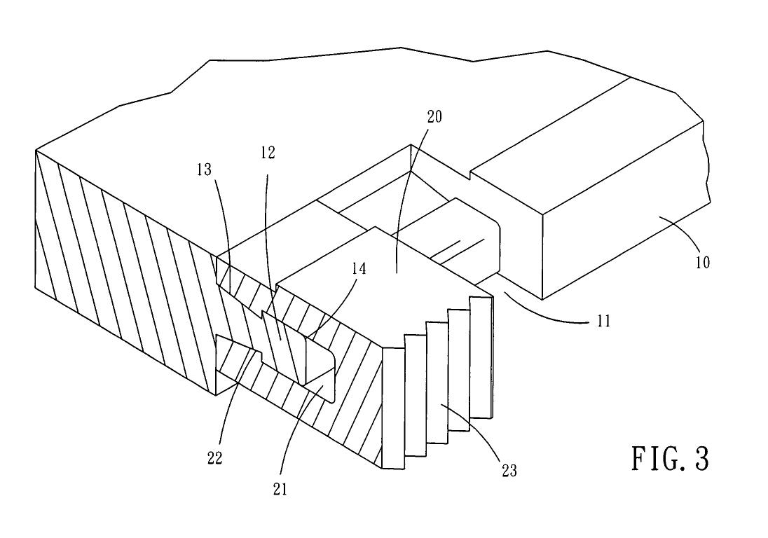

Referring to FIG. 3, upon latching the write-protect device 20 onto the slideway 12, the guiding slot 21 of the write-protect device 20 is pressed into an exterior part of the slideway 12 after aligning the guiding slot 21 on the write-protect device 20 with the slideway 12, such that the latching hooks 21 at the upper and lower ends of the guiding slot 21 can be latched with the latching slots 13 at the upper and lower ends of the slideway 12, thereby firmly latching the write-protect device 20 onto the exterior part of the slideway 12 without falling off.

Moreover, to facilitate successfully latching the write-protect device 20 onto the exterior part of the slideway 12, guiding wedges 14 are installed at an upper and lower sides in a front part of slideway 12 respectively. Therefore, when the write-protect device 20 is being latched onto the slideway 12 by the means of the guiding slot 21, an opening of the guiding slot 21 can be expanded toward an upper and lower sides by the guiding wedges 14 at the upper and lower sides in the front part of slideway 12, so as to be latched onto the exterior part of the slideway 12. When the latching hooks 22 at a top of the guiding slot 21 are pushed to the positions of latching slots 13, the latching hooks 22 can be latched into the positions of the latching slots 13 with a elastic restoring force themselves, so as to firmly latch the write-protect device 20 onto the slideway 12 without easily creating a falling-off phenomenon.

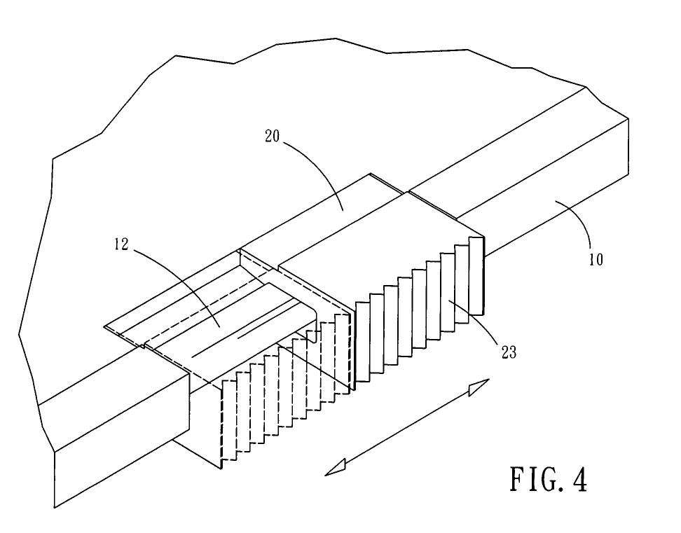

Furthermore, as shown in FIG. 4, upon latching the write-protect device 20 onto the exterior part of the slideway 12, as the slideway 12 is a little longer than the write-protect device 20, a position of the write-protect device 20 can be adjusted forward or backward on the slideway 12 in order to determine the position of the write-protect device 20 through electronic products or card readers, so as to determine whether the memory card body 10 is in a writeable or write-proof status, thereby avoiding carelessly writing unnecessary data into the memory card body 10 through a simple operation.

It is worth to mention that the memory card body of the present invention is primarily made by a one-piece ejection molding process, therefore it is very convenient in the manufacturing process, and thus can reduce a troublesome of human labor, a human error, and imperfection, thereby possessing effects of improving quality and productivity, and lowering a manufacturing cost. In addition, the write-protect device and the memory card body are assembled with a simple structure, thereby possessing an effect of fast assembling, and assuring not vulnerable to a falling off between the write-protect device and the memory card body.

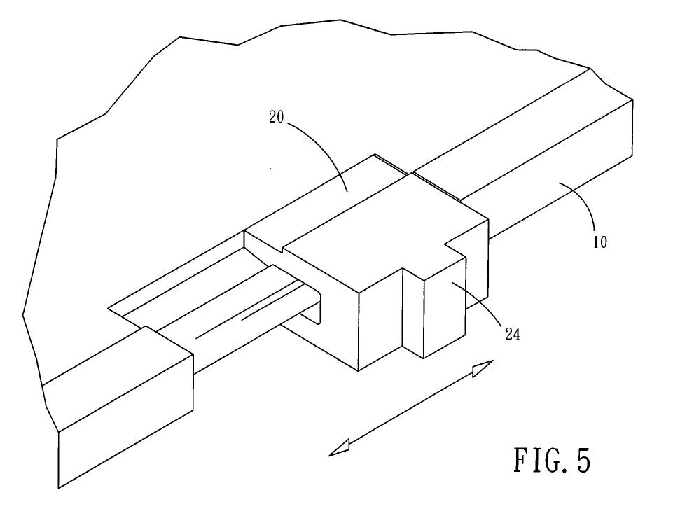

Moreover, to facilitate adjusting a forward and backward position of the write-protect device 20 on the slideway 12, a saw-tooth slip-proof thread 23 or a raised part 24 as shown in FIG. 5 is mounted on an outside wall of the write-protect device 20 to increase a friction force, thereby facilitating successfully pushing the write-protect device 20.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A memory card structure comprising a memory card body made by a one-piece ejection molding process, with a notch located at one side thereof and a slideway protruded out from the notch; latching slots located at an upper and a lower sides of the slideway; a write-protect device latched onto the slideway; a guiding slot located on the write-protect device at a position corresponding to the slideway, and latching hooks located at an upper and a lower ends, corresponding to the latching slots, of the guiding slot.

2. The memory card structure according to claim 1, wherein the slideway is a little longer than the write-protect device.

3. The memory card structure according to claim 1, wherein guiding wedges are located at an upper and a lower sides at a front part of the slideway respectively.

4. The memory card structure according to claim 1, wherein a saw-tooth slip-proof thread is located at an outside wall of the write-protect device.

5. The memory card structure according to claim 1, wherein a raised part is located at an outside wall of the write-protect device.
